(19) United States
(12) Patent Application Publication
(10) Pub. No.: US 2016/0321702 A1
(43) Pub. Date: Nov. 3, 2016

(54) PERMITTING A BUSINESS WITH PHYSICAL LOCATIONS TO CONNECT WITH THEIR CUSTOMERS ON THEIR MOBILE DEVICES (XONE)

(71) Applicant: Yext, Inc., New York, NY (US)

(72) Inventors: Howard C. Lerman, New York, NY (US); Thomas C. Dixon, New York, NY (US); Kevin Caffrey, New York, NY (US)

(21) Appl. No.: 15/096,537

(22) Filed: Apr. 12, 2016

Related U.S. Application Data
(60) Provisional application No. 62/153,741, filed on Apr. 28, 2015.

(51) Int. Cl. G06Q 30/02; H04W 64/00

(52) U.S. Cl. CPC G06Q 30/0267; G06Q 30/0259; G06Q 30/0261; H04W 64/006

(57) ABSTRACT

A server may receive from a mobile device, a first identifier identifying a service associated with a beacon device. The server may receive from the mobile device one or more identifiers associated with a physical location of the beacon device. The server may receive from the mobile device a device identifier associated with a user of the mobile device. The server may match the device identifier to an identifier in a list of device identifiers that correspond to a media slot controlled by an ad network of mobile devices that are in proximity to a location of a business in view of the first identifier and the one or more identifiers. The server may transmit to the mobile device an advertisement intended for mobile devices that are in proximity to the physical location associated with the beacon device.

### CROSS-REFERENCE TO RELATED APPLICATIONS

This application claims the benefit of U.S. provisional patent application No. 62/153,741 filed Apr. 28, 2015, the disclosure of which is incorporated herein by reference in its entirety.

### TECHNICAL FIELD

Examples of the present disclosure relate to a method and system to permit a business with physical locations to connect with their customers on their mobile devices.

### BACKGROUND

iBeacon technology built into iOS™ devices permits applications (hereinafter “apps”) running on mobile devices (e.g., an iPhone) to register to be notified and to perform actions when they are in the vicinity of compatible beacon devices (e.g., an “iBeacon”).

These beacon devices may be Bluetooth Low Energy (BLE) devices that advertise their presence according to the BLE standard. In non-beacon applications of BLE, these advertisements are used, e.g., by a smart watch device or a heart rate monitor device to notify a smartphone that the smart watch device or a heart rate monitor device is present and is ready to provide services. With iBeacon devices, however, the beacon devices are BLE devices that advertise their presence but are not configured to perform other functions. The advertisement is meant only to indicate that the iBeacon is present.

This is useful only if the advertisement also indicates something about which particular beacon is present. When a BLE device advertises its presence, the BLE device may transmit 31 bytes of arbitrary data that is available to devices that receive the advertisement. The iBeacon standard specifies that part of this to be used by the iBeacon to transmit three IDs to identify itself. These IDs include:
A UUID (universally unique identifier), a 128-bit value that identifies one or more beacons as being of a certain type or from a certain organization;
a major value, which is a 16-bit integer that distinguishes between beacons with the same UUID; and
a minor value, which is a 16-bit integer that distinguishes between beacons with the same UUID and major value.

In the iOS™ platform employed by iPhones and iPads, there is corresponding functionality that permits apps running on the iPhones and iPads to register to be notified when the iPhones and iPads enters beacon regions, defined as being near a beacon either with (i) a given UUID, (ii) a given UUID and major value, or (iii) a given UUID, major value, and minor value.

Apps register with iOS™ to monitor beacon regions using UUIDs, major values, and minor values that have been coordinated in advance. For example, a department store of a business may use the same UUID for all of its beacons. The business may use a different major value for each of its stores and a different minor value for each of its departments. Knowing these values, the department store's app understands the meaning of the beacons the app sees.

When an app is being used in the foreground and is notified about entering a beacon region, the app may perform anything in response. In a typical application, a user may have a store's app open to navigate around and learn about the store, and the app may tell the user which part of the store the user is in and what specials are available there.

If an app is running in the background and is notified about a beacon, the app is given a short amount of time to run code. Typically, the app uses this time to send an alert to the user or record that the user was near the beacon.

The main intention of iBeacon technology is for retail stores or other venues to enhance their own apps with information relevant to the consumer's exact location within that venue.

For example, baseball stadiums have installed beacons near the turnstiles, and if a consumer opens the MLB app when near the turnstile, the consumer's ticket is automatically displayed. Once the consumer is in the stadium, the user may receive specials on food when the consumer approaches certain concession stands or when the consumer needs to obtain directions toward their seats.

Consumers who have the app for a retail location may receive an alert welcoming them, and if they open the app, they may see a welcome message with current specials. If they approach certain areas of the store, they may see sales or offers relevant to that area. Apps frequently provide more information about products that the consumer is near. For example, in the section of an electronics store where a certain type of product is featured, the app may surface information about that product.

Even before iBeacon technology was introduced, apps employing the iOS™ platform have been able to register to be notified when the mobile device is in a specific geographic region using functionality called geofencing. For example, a to-do list app may alert a user to pick up milk when the mobile device are near the grocery store. This technology is based on the positioning functionality built in to iOS™, which relies on a combination of GPS and WiFi signals to establish the user's location.

The process for an app to register for geofencing and the results when the user enters a registered region are similar to those used to register and respond to iBeacons as described above. The difference is that the app specifies a geographic region rather than beacon identifiers.

Because geofencing relies on the positioning features of the device, geofencing is subject to accuracy limitations not present with iBeacons. A mobile device encountering an iBeacon will consistently detect the iBeacon. Geofencing, on the other hand, is subject to more error, especially in urban environments and indoors. A mobile device tracking whether a user of the mobile device is in a certain location may think the mobile device is in that location when it is not, or may fail to register when the mobile device is present in that location.

For detecting that the mobile device is in one a specific store rather than the one next door or that the mobile device is in a certain department rather than another, geofencing is inadequate.

The general approach of using advertisements from Bluetooth LE devices to monitor for location was introduced by Apple with iBeacon. Apple created specific support for this approach in iOS™. However, this approach can be implemented on any device that has a Bluetooth LE radio if the software has adequate access to the device.

The specific functionality for listening for beacons, based on the iBeacon standard, was built into iOS™ and is restricted to listening for beacons in at most 20 regions simultaneously.

Android and other smartphone platforms are given much more flexibility to make use of a Bluetooth™ radio when writing software. For that reason, the same effects may be achieved on Android and other platforms as may be with iOS™ by having an app run in the background and occasionally check for the presence of target beacons. This presents challenges related to preserving battery life, not slowing down the device, etc.

### SUMMARY

The above-described problems are remedied and a technical solution is achieved in the art by providing a system with the ability to monitor a large network of beacons in an energy efficient away across both iOS™ and Android™ platforms. Visits to stores may be monitored in the background by pre-fetching content based on GPS locations. This combination of GPS and iBeacon permits for efficient battery usage without sacrificing the user experience (e.g., tips are preloaded at a destination). Advertising identifiers may be collected in the background and used after the fact. Additionally, iBeacon applications may be executed in real time.

To this effect, a method of operating a server is provided. The server may receive from a mobile device a first identifier, one or more identifiers, and a device identifier (e.g., an anonymous identifier). The server may receive from the mobile device, an indication that the mobile device has received a tap on a message provided by a software development kit (SDK) in the mobile device notifying a user of the mobile device that information associate with a local business at the physical location associated with the beacon device is available. The server may transmit to the mobile device information about the local business at a physical location formatted for display on the mobile device.

The server may receive an indication that the mobile device has exited the range of the beacon device. The server may receive an indication that the mobile device has re-entered the range of the beacon device after having exited the range of the beacon device. The server may receive information about the local business at the physical location to transmit to the application when the mobile device enters or exits the range of the beacon device. The server may transmit one or more advertisements at a specified time after the mobile device has exited the physical location associated with the beacon device.

Upon the mobile device entering the vicinity (e.g., range, zone) of the beacon device, the server may receive from the mobile device, the first identifier identifying a service associated with the beacon device. The server may receive from the mobile device the one or more identifiers associated with a physical location of the beacon device. The server may receive from the mobile device the device identifier associated with a user of the mobile device.

The server may match the device identifier to an identifier in a list of device identifiers that correspond to a media slot controlled by an ad network of mobile devices that are in proximity to a business in view of the first identifier and the one or more identifiers. The server may transmit to the mobile device an advertisement intended for mobile devices that are in proximity to the physical location associated with the beacon device.

Prior to deploying the beacon device, a client associate with the local business may employ a graphical user interface of the server to log into an ad network. The client may create in the ad network using the server, an advertising campaign intended for visitors of a business at the physical location of the local business. The server may transmit to the ad network, the first identifier, the one or more identifiers, and the device identifier to be stored in a list of identifiers of mobile devices that have returned to the local business at the physical location.

Later, the server may receive from the client, a login to an analytics engine of the server. The server may receive from the client a request for a report on visits generated by advertising campaign intended for mobile devices that are in proximity to the local business at the physical location. The server may display to the client entries in a list identifying mobile devices that have returned to the local business associated with the physical location of the beacon device.

The server may receive in a graphical user interface from a developer of an application executed by the mobile device that provides the first identifier and the one or more identifiers, information about the local business at the physical location provided by the application for the purpose of monetizing the application. Monetizing the application may comprise how much the developer desired to be paid any time an advertisement is transmitted to the application.

The above-described problems are remedied and a technical solution is achieved in the art by providing a method of operating a software development kit (SDK) installed in an application executed by a processor of a mobile device. The SDK installed in an application executed by a processor of a mobile device (e.g., an iPhone™, Android™ phone, etc.) may receive a first identifier transmitted by a beacon device. The first identifier may identify a service associated with the beacon device or may be an identifier for all beacon devices. The SDK may identify one or more identifiers associated with a geographical zone comprising a volume defined by a pre-determined distance from the beacon device. The predetermined distance from the beacon device may be centered about a physical location of the beacon device and terminated by the physical location of the mobile device. Identifying the one or more identifiers may comprise searching for a specific one or more identifiers assigned by the local business to a location associated with a geographical zone. Identifying the one or more identifiers may comprise ranging for the one or more identifiers associated with a predetermined radius of the location of the beacon device.

The SDK may report to the sever the first identifier and the one or more identifiers. The processor of the mobile device may report to the server a device identifier associated with a user of the mobile device. The processor of the mobile device may open the application responsive to reporting the first identifier and the one or more identifiers. The application may display a message to appear in the application indicative of the availability of information (e.g., a tip, photo filters, song playlists, etc.) associated with a business at the location.

The mobile device may receive a tap on the message from the user. The application may transmit to the server an indication of a tap on the message. The application may receive and display the information associated with a business at the location.

The mobile device may transmit an indication that the mobile device has exited the range of the Xone beacon device. The mobile device may further transmit an indication that the mobile device has entered the range of the Xone beacon device after having exited the range of the Xone beacon device.

The application may be a third party application provided by the local business.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of an example system in which examples of the present disclosure may operate.

FIG. 2 is a screen shot of a mobile device and screen, wherein an Xone SDK causes a tip to appear in an app running on the Xone SDK so that a consumer knows that store information is available.

FIG. 3 is a screen shot of a mobile device Xone screen information about the local business to the consumer in the app on the Xone screen.

FIG. 4 is a flow diagram illustrating an example of a method to operate a Xone server.

FIG. 5 is a flow diagram illustrating an example of a method to operate an Xone software development kit (SDK) installed in an application executed by a processor of a mobile device.

FIG. 6 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION

A main feature of Xone makes use of the existing capability provided by advertising platforms to target users based on a platform-agnostic mobile advertising identifier (hereinafter, “a device identifier”). The device identifier is available to ad platforms that serve ads on mobile devices. A device identifier remains consistent between sessions on the mobile device unless/until the user chooses to reset the device identifier. In this way, the device identifier anonymously identifies users across their activity on the mobile device.

Ad networks use the device identifier to select which ads to show users based on their previous activity, such as which ads the user responded to before. The device identifiers also allows advertisers to determine the effectiveness of campaigns they run by matching the device identifiers associated with users who perform advertised actions (e.g., installing a specific app or making a purchase) to the device identifiers of the users who saw the corresponding ad.

Advertisers are often in a position to collect the device identifiers of people they want to target, for example by collecting device identifiers of people who use their app or have responded to their previous ads. Mobile ad networks, in turn, provide the means for advertisers to run a campaign targeted to a particular set of device identifiers.

The retargeting and attribution features of Xone make use of this existing capability.

In an example, device identifiers may also be employed to provide insight to clients (e.g., how often a user may return to a store for a repeat visit).

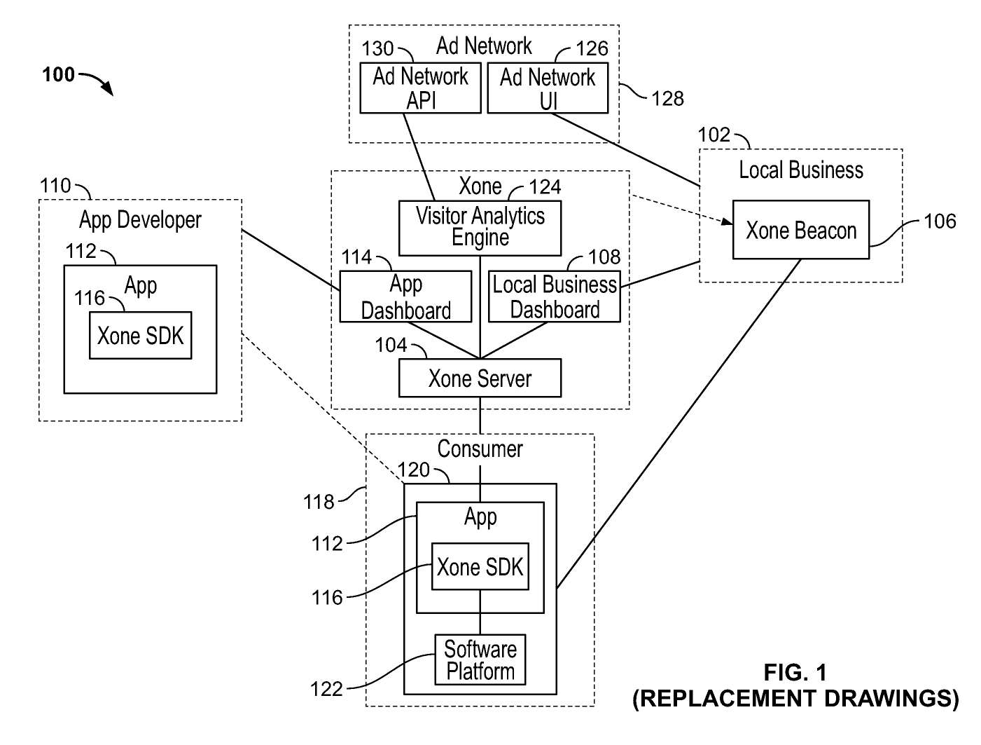

FIG. 1 is a block diagram of an example Xone system 100 in which examples of the present disclosure may operate. The system 100 includes a server 104 (hereinafter “the Xone server 104”) as part of a hardware/software platform configured to implement an application dashboard 114 and a local business dashboard 108. The application dashboard 114 permits application developers 110 to configure how their application(s) 112 employing a software development kit 116 (SDK) is to be monetized and to view statistics concerning the application(s) 112 that the application developer 110 may develop the SDK 116 (hereinafter “the Xone SDK 116”). The Xone SDK 116 may be downloaded and installed in the application(s) 112 on a mobile device 120 (e.g., an iPhone™, an Android™ phone, etc.) by a user (e.g., a consumer 118) of the mobile device 120. The application(s) 112 employing the Xone SDK 116 may be configured to run on a mobile software platform 122 (e.g., iOS™, Android™, etc.) executed by a processing device (not shown) within the mobile device 120.

The local business dashboard 108 permits an entity (e.g., a local business 102) to configure a beacon device 106 (hereinafter “an Xone beacon device 106”) to place the Xone beacon 106 in a location of the local business 102, and to view statistics concerning the usage of the Xone beacon 106 by the applications 112 that detect the presence of and take actions in response to the user (e.g., a consumer 118) of the mobile device 120 entering or exiting the vicinity or “xone” of the Xone beacon device 106.

The local business 102 may sign up for Xone service. The Xone server 104 may provision a new Xone beacon 106 for the local business 102, assigning the Xone beacon 106 the proximity ID used for all Xone beacons 106 and a major and minor value associated with the local business 102. The Xone server 104 may send to the local business 102 the Xone beacon 106 and the local business 102 places the Xone beacon 106 near the entrance to a store. The local business 102 may log into the Xone local business dashboard 108 of the Xone server 104. The local business 102 may indicate that their beacon is installed and should be activated. The local business 102 may enter into the Xone local business dashboard 108 information about their business to be used in the Xone service (e.g., the Xone server 106), e.g., name, address, phone number, welcome message, an offer or coupon, WiFi information, and links to their social sites and apps.

An application developer 110 desiring to monetize an application 112 may sign into the Xone server 104. The application developer 110 may log into the application dashboard 114 of the Xone server 104 and may enter the names and details of the application 112 to be monetized. The Xone server 104 may transmit to the application developer 110 the Xone SDK 116, which the application developer 110 may install in the application 112. The application developer 110 may determine that the installation was performed successfully using tools provided by the Xone system 100. The application developer 110 may submit their updated application 112 to an app store.

A consumer 118 may download the application 112 and install the application 112 in their mobile device 120 (e.g., an iPhone™). When the consumer 118 runs the application 112 for the first time, the application 112 may request that the consumer 118 give the application 112 permissions needed for the Xone server 104, including permission to monitor location in the background. The Xone SDK 116 may register with the software platform 122 to listen for any Xone beacons 106 with the proximity UUID used by the Xone server 104. Alternatively, permissions may be installed at application download time.

The consumer 118 may enter the local business 102. The Xone beacon 106 may be transmitting the UUID that the Xone SDK 116 has asked to monitor, in which case the software platform 122 wakes up the Xone application 112 and notifies the Xone SDK 116 that the mobile device 120 is near the Xone beacon 106. The Xone SDK 116 briefly ranges for beacons, which permits the Xone SDK 116 to determine the major and minor values of the specific beacon the Xone SDK 116 has encountered. The Xone SDK 116 may report to the Xone server 104 that the Xone SDK 116 has encountered an Xone beacon 106 with the detected major and minor values. (If multiple applications 112 with the Xone SDK 116 are on the mobile device 120, all of the applications 112 take the same steps.). The Xone server 104 may record all of this information.

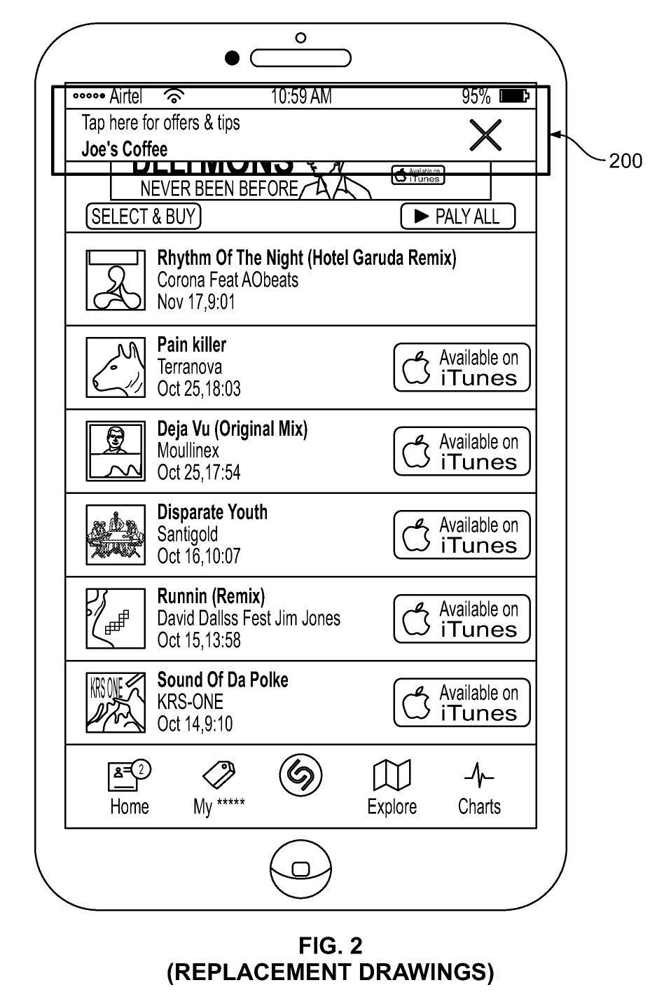

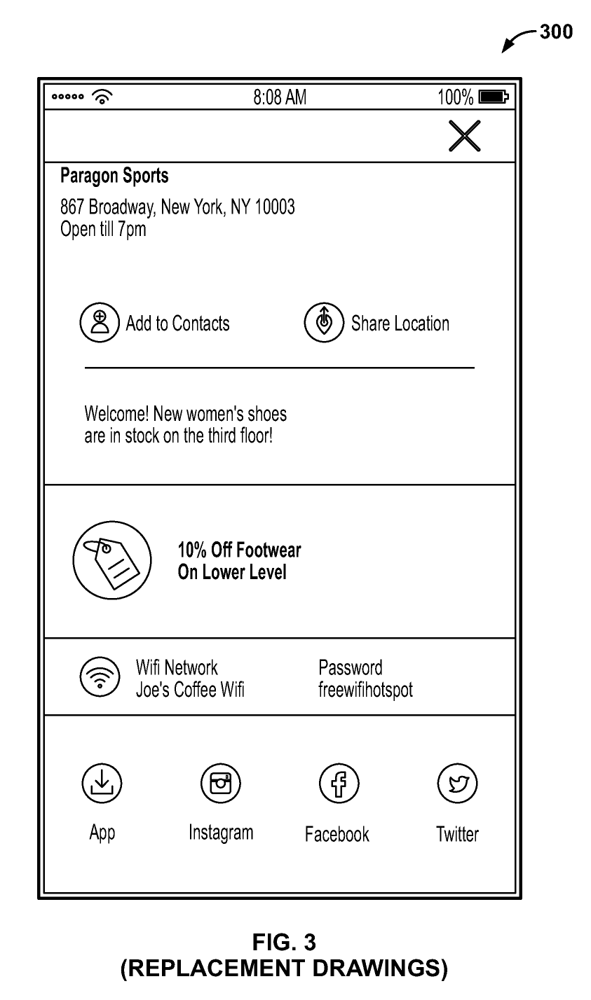

The consumer 118 opens the Xone application 112 while in the store. As shown in FIG. 2, the Xone SDK 116 causes a message 200 (e.g., a tip) to appear in the Xone application 112 so that the consumer 118 knows that store information is available. If the consumer 118 is interested in the store information, they tap the message 200 (e.g., a tip). The Xone SDK 116 may contact the Xone server 104, which returns information about the local business 102 formatted for display on the mobile device 120. The Xone SDK 116 may display the information about the local business 102 to the consumer 118 in the Xone application 112 on an Xone screen 300 as shown in FIG. 3. The consumer 118 may view the information on the Xone screen 300. The Xone screen 300 also provides some interactive functionality: the consumer 118 may add information about the local business 102 to the phone's contacts database, may text the location of the local business 102 to someone, and may access a coupon from the local business 102 which may be added to the passbook feature on the mobile device 120 (e.g., an iPhone™). When the mobile device 120 (e.g., an iPhone™) leaves the range of the Xone beacon 106, the mobile device 120 may report the event to the Xone server 104.

The local business 102 may log in to the local business dashboard 108 and may employ the visitor analytics engine 124 to view analytics on store visitors have applications 112 associated with the Xone system 100, including how many people came to their local business 102, how long they stayed, how many viewed the Xone screen 300 while in the local business 102, and how frequently they came back. This data may be assembled from the data reported from the Xone SDK 116 to the Xone server 104 and may accumulated whether or not the Xone screen 300 was shown on a given visit.

The local business 102 may log into the local business dashboard 108 and may access the visitor analytics engine 124. The local business 102 may download the device identifiers of recent visitors to their local business 102 for the purpose of retargeting the recent visitors. The local business 102 may log into an ad network user interface (UI) 126 of an ad network 128 and create a new advertising campaign intended for previous visitors to their local business 102. In setting up who should be targeted in the campaign, local business 102 may upload the list of device identifiers that they downloaded previously.

When consumers 118 who have previously been in the local business 102 (whose device identifiers were in the list uploaded into the ad network UI 126) are viewing a media slot controlled by the ad network 128, the customers 118 may be shown an advertisement intended for previous visitors to the local business 102. The ad may induce the consumer 118 to return to the local business 102. When the consumer 118 does so, the visit of the mobile device 120 with that device identifier is recorded by the Xone server 104 in the same manner as for the first visit as described above.

The local business 102 may log into the visitor analytics engine 124 and may select a report on visits generated by the campaign the local business 102 ran. The Xone server 104 may compare the list of device identifiers supplied previously with those who since visited again. The local business 102 can thereby see how many people who saw the ad returned to the store.

For certain application, there may be privacy restrictions. In an example, the local business 102 may not be permitted to know which consumers saw the ad—however, the local business 102 may be permitted to know if the consumers were in a group that the ad was targeted to. This is because not all consumers in a custom audience for an ad may see an ad (say, if they did not log onto Facebook or if other ads were set to be served before those provided by the local business 102). As described above, the applications 112 running on the mobile device may register to be notified when they enter beacon regions, defined as being near an Xone beacon 106 either with (i) a given UUID, (ii) a given UUID and major value, or (iii) a given UUID, major value, and minor value. This technique is known as “monitoring” for a region. The applications 112 may only monitor a total of 20 regions at a time.

When a mobile device 120 enters a beacon region that the Xone application 112 is monitoring, the Xone application 112 may be told which region was entered but is not given any other information about the specific Xone beacon 106 that was encountered. If the region was defined by a UUID, then the Xone application 112 effectively knows the UUID of the nearby Xone beacon 106 but not its major and minor value. Only if the region to be monitored was defined by the UUID, major value, and minor value does the Xone application 112 know the complete identification of the Xone beacon 106.

However, since only 20 beacon regions can be monitored, an application 112 that wants to listen for thousands of different beacons with the same UUID cannot simply register for each of the beacons. Instead, the application 112 needs to register for a region defined only by the UUID, and then when the application 112 is notified that the application 112 has entered that region, the application 112 may carry out a more resource-intensive process known as ranging, which permits the application 112 to obtain the exact major and minor IDs of the beacons in its geographical vicinity with that UUID.

This procedure is known, but it has a few drawbacks. First, there may be some delay in taking action based on the consumer 118 entering the area of an Xone beacon 106 because the application 112 must range, send the major and minor IDs found to the Xone server 104, and obtain a response back indicating what should be done based on those IDs. Second, if two beacon regions with the same UUID overlap, the application 112 has no way of knowing that the consumer 118 has exited the first region and entered the second region, because from the software platform's 122 perspective, the consumer 118 is still within the region defined by the UUID so the software platform 122 doesn't tell the application 112 that the consumer 118 has exited.

A local business 102 may have multiple locations, in which case the system 100 may sign each one up and may provision an Xone beacon 106 for each but associates the multiple locations in the same account. The Xone beacons 106 may be shipped with identifying information so that the customer 118 knows where the Xone beacons 106 should be deployed. For complex locations, there may be multiple zones in one venue. In this case, the consumer 118 may indicate how many zones they have and the system 100 provisions an Xone beacon 106 for each. The Xone beacons 106 may be shipped with identifying information so that the customer 118 knows which Xone beacon 106 goes in which zone. Larger locations or smaller zones may require different Xone beacons 106, or the same Xone beacons 106 configured with a different power setting, to provide the correct coverage. In that case, the Xone beacons 106 corresponding to the supplied requirements may be provisioned. Large local businesses 102 or resellers may not know in advance how each beacon 106 may be employed. In that case, the beacons 106 may be assigned major and minor values but are not associated in advance with particular locations. The local businesses 102 may want to employ the Xone beacon 106 for an event or some other non-fixed location. In this case, an Xone beacon 106 may be provisioned but may not activated.

If multiple Xone beacons 106 are involved (either for multiple locations are multiple zones), the local business 102 may place them in the correct place based on labels provided. The local business 102 or resellers who do not know in advance where each Xone beacon 106 will be used may place an arbitrary one of the supplied Xone beacons 106 into a given location or zone and then indicate to the Xone Server 104 which location and zone that Xone beacons 106 is for. The local business 102 or reseller either supplies an ID from a label on the Xone beacons 106 to indicate to the Xone server 104 which beacon 106 they have installed in a one or more locations, or local business 102 or reseller uses an installation app provided by the Xone system 100 that identifies the beacon 106 based on its major and minor ID and allows the customer or reseller to associate the identified the Xone beacon 106 with a specific location or zone within it.

If the local business 102 has a beacon intended to be used for an event or non-fixed location, then before the event occurs, the local business 102 may log into the local business dashboard 108 and indicate that the local business 102 wants the Xone beacon 106 to be activated. Alternatively, the local business 102 may employ the installation app, which identifies the Xone beacon's 106 major and minor ID and reports to the Xone server 104 that the local business 102 wants the Xone beacon 106 to be activated.

In some cases, a local business 102 may not wish to log back into the local business dashboard 108 after placing their initial order and supplying business information. However, the local business 102 cannot just consider the Xone beacon 106 active as soon as it is shipped, because consumers 118 who were near the Xone beacon 106 while it was in transit would be treated as though they were actually in the local business 102. In that case, the Xone system 100 may place the beacon 106 into “auto install” mode. In this mode, the Xone applications 112 are ready to begin responding to the beacon 106 as soon as it is shipped, but the Xone applications 112 may do so if the Xone beacon 106 is seen within a radius of the known latitude and longitude for the intended location. In another example, the Xone applications 112 may check, during a first visit, whether a given latitude/longitude is in the intended location of the Xone beacon 106. In an example, subsequent visits may not be checked. In this way, the local business 102 does not need to take any action other than installing the Xone beacon 106, but consumers 118 near the Xone beacon 106 while it is in transit are not erroneously treated as being in the local business 102.

If the local business 102 is setting up multiple locations or multiple zones, the local business 102 may supply information about each of the locations and indicate what information (such as a welcome message or offer) should vary within the location by zone. If the zone being configured is for an event or other non-fixed use, the local business 102 does not need to supply an address or phone number. However, the local business 102 may be asked to supply the approximate geographical location of the intended use if possible to help with the operation of the Xone system 100.

The Xone SDK 116 may be installed by the local business's 102 own application 112. This permits the local business 102 to take advantage of the visitor analytics and retargeting capabilities of the Xone system 100 for local businesses 102 who have installed their first-party application 112.

In addition to registering to listen for any Xone beacons 106 with the proximity UUID used by the Xone system 100, the Xone SDK 116 may register to be notified when the consumer 118 leaves their current approximate geographic area. Every time the consumer's 118 location substantially changes, the Xone SDK 116 may contact the Xone server 104 and may ask for information about Xone beacons 106 and locations in that approximate area. This is done for two reasons: first, to provide the best user experience, it is important that when a consumer 118 enters the local business 102 and opens a participating application 112, information about that location is available quickly. To enable this, the Xone SDK 116 may cache information about locations around the consumer's 118 current position that participate in the Xone system 100 so that the information is readily available without having to make a call to the Xone server 104 once the consumer 118 enters the local business 102. This eliminates a lag and even makes it possible to provide store information if the consumer 118 has entered a store where the consumer 118 does not have internet access. Second, for the reasons described above, if the Xone SDK 116 only listened for the beacon region defined by the proximity UUID, it becomes more difficult to quickly determine which beacon 106 the consumer 118 has approached, especially when the consumer 118 is moving between beacons 106 with overlapping ranges. For that reason, whenever the consumer 118 moves to a substantially new area, the Xone server 104 may return to the Xone SDK 116 a list of the major and minor IDs of the Xone beacons 106 in the surrounding locations. The Xone SDK 116 registers to monitor for regions defined by those exact IDs. In this way, the Xone SDK 116 may be notified when the consumer 118 enters the region of a new Xone beacon 106 without having to range, even if the consumer 118 is still in the range of a previous Xone beacon 106.

If the Xone SDK 116 was monitoring for the specific major and minor ID of the Xone beacon 106 because of the pre-fetching system described above, the Xone SDK 116 knows which Xone beacon 106 it has approached without having to range.

Some applications 112 may already have functionality related to location discovery, and in that case there is a more integral way to make use of the information that the consumer 118 has entered a specific location and offer more information. In that case, rather than causing a message (e.g., a tip) to appear, the Xone SDK 116 may supply the application 112 with information about the location, and the application 112 may inform the consumer 118 about the location they have entered in a more native way.

There may be some applications 112 that have a natural way to present in-store information as part of the app experience rather than an overlay provided by the Xone SDK 116. In that case, the Xone SDK 116 may supply the necessary information about the location (such as name, address, WiFi info, links, etc.) directly to the application 112, which presents the information in a native way. The listing may include additional functionality not shown in these examples but uniquely suited to the in-store experience, such as a way to ask the store for help, an opportunity to rate the business or supply feedback, or a way to take a picture and share it with the store for their use.

If the local business 102 has multiple locations, the local business 102 may view data on device identifiers associated with the consumers 118 broken down by location, including data about device identifiers associated with the consumers 118 who visit multiple locations. If the local business 102 has multiple zones in a single location, the local business 102 may view data on the device identifiers associated with the consumers 118 in each zone and movement between zones. The visitor analytics engine 124 may use data about the coverage of the Xone network 100 of applications 112 compared to the full population to extrapolate an estimate of total number of device identifiers associated with the visitors/consumers 118 from those that were detected by the Xone system 100.

Rather than target all previous visitors to the local business 102, the local business 102 may set up rules to select which device identifiers associated with the consumers 118 they want to target. The local business 102 may filter to include only those device identifiers associated with the consumers 118 who visited within a certain time period (e.g., within the last X weeks), visited at least or at most a certain number of times, visited for at least a certain duration, visited multiple of their stores, or visited a certain zone within their store. If the local business 102 plans to retarget using one of the major ad networks 128, rather than download the device identifiers themselves, the local business 102 may establish a link between their Xone account and their account on that ad network 128. The visitor analytics engine 124 may call the ad network API 130 to retrieve a list of the campaigns that the local business 102 runs, and the local business 102 may select one that they want to target to the device identifiers associated with the consumers 118 to the local business 102. (Alternatively, the local business 102 may choose to create a new campaign, which the visitor analytics engine 124 may create for them through the ad network API 130.). The Xone server 104 may automatically set the targeting on the selected campaign to the set of device identifiers that the local business 102 wishes to target, permitting the local business 102 to skip uploading the device identifiers. Optionally, the local business 102 may target only a subset of device identifiers as defined by a rule as described above.

Whenever the set of device identifier matching the rule changes (as new people visit, visits are far enough away that they do not match the criteria, etc.), the Xone server 104 may automatically update the targeting of the campaign via the ad network API 130 to the new set of device identifiers. Optionally, the local business 102 may select to receive an email with the latest set of device identifiers matching a certain rule periodically. Optionally, the local business 102 may choose to download only every other device identifier that matches specific criteria in order to run a campaign and use them for an A/B test (then running another campaign with the other half of the device identifiers or using them as a control).

In one example, campaigns may be automatically updated as the device identifiers of consumers 118 who meet the criteria change.

If the local business 102 chose to run A/B test campaigns, the Xone server 104 may show the user a comparison of how the two conditions performed in getting consumers 118 to return to the local business 102. If the ad network 128 can supply the device identifiers associated with the consumers 118s that saw the ad, not just the ones that were targeted, the Xone server 104 may display a report of how many consumers 118 who actually saw the ad returned to the store. If the ad network 128 does not supply who saw the ad but allows conversion analysis if supplied with the device identifiers associated with consumers 118 who converted, the Xone server 104 may supply the ad network 128 with the device identifiers of consumers 118 who are in proximity to the store and when they did so, allowing the local business 102 to see the conversion analysis through the ad network UI 126.

Whenever a mobile device 120 running the Android version of the Xone SDK 116 encounters a beacon 106, the Xone SDK 116 records information broadcast by the Xone beacon 106 about its current battery level. This information is stored in the Xone server 104. When the battery level falls below a threshold, the Xone server 104 automatically orders a replacement beacon for the local business 102.

Whenever a mobile device 120 running the Xone SDK 116 detects an Xone beacon 106, the Xone SDK 116 may report its latitude and longitude. Though this information is not accurate enough to provide the Xone service, it gives a basic idea where the Xone beacon 106 is located. If the Xone beacon 106 has moved substantially from where it was before, the Xone server 104 may notify Xone personnel to investigate. If the Xone personnel determine that the local business 102 has moved the beacon 106 somewhere outside the intended location in order to collect analytics on consumers 118 other than their customers, they may cancel the local business's 102 service.

In one example, the Xone server 102 may not send messages—instead of sending messages, if a consumer 118 has an Xone application 112 open while s/he is in a local business location that has installed a Xone beacon, an in-app alert may display in the application 112. If the consumer 118 taps on the in-app alert, an in-store listing (called an Xone Screen) may appear with tips about the location. The Xone Screen will generally be the full screen size and all this will occur in the application 112. Through the Xone Screen, the consumer 118 may engage with the location of the local business 102 in a variety of ways, such as by downloading a coupon, taking a photo of the store, downloading the app, etc. Actions may connect with other phone apps (e.g., camera, passbook) as necessary to complete the action. An application 112 with the Xone SDK 116 may listen to Xone beacons 106 even when the application 112 is not open. If an unopened application 112 with the Xone SDK 116 detects an Xone beacon 106, the Xone SDK 116 may collect the following information: device identifier, location (based on beacon data and other geofencing) and the time and duration of interaction with the Xone beacon 106 (this is visitor data). Visitor data may be stored in Xone system 100.

In an example, even when an Xone application 112 is not communicating with an Xone beacon 106, the Xone SDK 116 may be checking that user's location, in order to determine whether the user is near any Xone beacon 106. Based on the Xone application 112/user's location, the Xone SDK 116 may listen for only Xone beacons 106 within a pre-determined distance from the mobile device 120 associated with the consumer 118 (hereinafter, a “zone”). This is an improvement over “ranging”. With ranging, once the user is in a certain range of beacons, the phone will listen for all beacons in the network. This drains batteries and is not allowed under iOS rules since applications may only listen to 20 UUIDs at a time. This is also an improvement over “ranging” when there are multiple Xone beacons 106 and a consumer 118 may be moving from one Xone beacon to another. Unless one is ranging continuously (which would drain batteries) the Xone SDK 116 cannot tell when someone has moved from one Xone beacon directly to another Xone beacon (e.g., if there is a beacon in the shoe department at Store A, and another next to the shoe department, in the jewelry department of Store A—with ranging, the Xone SDK 116 would not know when someone had moved from the shoe to the jewelry department). Listening only for Xone beacons 106 that are only within the area of the mobile device 120 associated with the consumer 118 also permits pre-loading of content for in-app alerts and Xone screens so that: the content is ready to load (and there is no loading delay) once the application 112 is opened in a business location with the Xone beacon 106 installed. The content will load once the application 112 is opened in a business location with the Xone beacon 106 installed even if the Xone beacon 106 is in a dead zone. If a smart beacon is employed (such as attribeacon), the Xone beacon 106 may have a basic message actually stored on it so that it may send the message to the user via Bluetooth™. In summary, the Xone system 100 may employ GPS for pre-loading content of nearby venues/beacons and determining the location of the mobile device 120 associated with the consumer 118 so that the beacons 106 in range can be monitored. Interaction with the Xone beacon 106 when the application 112 is open may trigger the delivery of the content.

The latitude/longitude of the mobile device 120 may be determined at the time that it first interacts with the Xone beacon 106. While latitude/longitude is not accurate or useful on its own, over time, having the latitude/longitude may help in the development of more accurate data on the locations of the Xone beacon 106 and the location of the mobile device 120 in relation to the Xone beacon 106 over time.

One advantage of the Xone system 100 is that businesses are able to retarget the device identifiers of consumers 118 based on the person actually having visited the local business 102—not just targeting passersby, etc. The Xone system 100 permits this because it determines when people have visited based on triggering the beacon, rather than geofencing, GPS, etc.

The specific formula for determining a visit may be based on a category of a local business 102; the length of a stay may matter. Based on a location, the length of stay may matter. Repeat visits within a certain period of time may not count.

In determining when a consumer 118 has left a beacon range, the Xone system 100 may use GPS and geofencing.

Xone beacons 106 may not stay in the correct location. This creates a problem because a local business 102 could install an Xone beacon 106 in their business location, and then later move the Xone beacon 106 to a competitor's business location in an effort to retarget the competitor's visitors. To ensure that Xone beacons 106 are being used responsibly (and clients are not putting them in competitors' locations), the Xone system 100 may determine the latitude/longitude on the mobile device 120 when the Xone beacon 106 is initially set up. The Xone system 100 may determine the latitude/longitude on the mobile device 120 as it triggers beacons—if an Xone beacon 106 is interacting with mobile devices 120 that are at a latitude/longitude not near where the Xone beacon 106 is supposed to be, the Xone beacon 106 may be turned off.

The above assumes that the business that has installed the Xone beacon 106 is a single-location business with only one beacon in the business location. The Xone system 100 may also work with multi-location businesses—for example, Business B could have a beacon in each store in Manhattan. Multi-location businesses can show different content for different stores and track visits across locations, and determine whether the same or different device identifiers are visiting each location. They can also determine which ads, etc., work best for which locations using attribution and retargeting as described below. The Xone system 100 may also work with multiple zones within the same business—for example, Business B could have an Xone beacon 106 in the prepared food section and in the fruit section. The Xone system 100 may permit for the same variations in content as above based on the area of the store that the person is visiting and tracking of where people visit within the store. An Xone beacon 106 may also be placed in a temporary location, such as a concert or event. The Xone system 100 would work the same as for permanent locations once the Xone beacon 106 was installed.

Visitor data may be used for attribution to gauge effectiveness of third party ad buys. An advertiser may run a mobile ad campaign to a certain audience of known device identifiers. The advertiser may place an Xone beacon 106 in its stores, and may collect a list of store visitors from the Xone system 100. The advertiser may match the device identifiers of visitors against the audience from the original campaign. The advertiser may see the percentage of users who saw their ad who visited their store. Visitor data may be used to retarget visitors who are in proximity to the business location by targeting a campaign on a third-party ad network (e.g. Facebook) towards device identifiers of users who are in proximity to the business location.

The Xone system 100 may permit clients to determine parameters for the groups of device identifiers for which the clients may want to seek attribution or to retarget, since device identifiers, location, time of beacon trigger and duration will all be stored. For example, a business location may determine to retarget only device identifiers of mobile devices that are in proximity to a business location within the last week and remained in that location for at least 20 minutes. If a business has multiple locations, the business may also include parameters across locations. For example, Business X may determine to retarget only device identifiers of users who have been in proximity to multiple Business X's in one day. Since the Xone system 100 incorporates in-app alerts and in-store listing that only appear when a consumer 118 is actually physically in a business location, a client may retarget only device identifiers based on which users tapped on the in-store listing while in the business location.

Clients may upload device identifiers into a third-party ad network via application programming interfaces (APIs), such as Facebook, Google or Twitter. It is possible to directly integrate with third-party ad networks such as Facebook, Google, Twitter etc. Integrating directly with third-party ad networks may permit the client to load device identifiers directly onto the ad network (such as Facebook) without leaving the Xone system 100 or downloading the device identifiers. Once there is integration, a client may create rules in the Xone system 100 to determine when an device identifier will be included in an integrated third-party ad network campaign, and the Xone system 100 may continue to include device identifiers that meet those criteria. For example, if there is a direct integration with Facebook, and Business C may create a rule that any device identifiers of mobile devices of users that visited Business C's 23^{rd} Street and Park at least twice a week will be targeted with a specific campaign in Facebook, the Xone system 100 may continue to add device identifiers that meet the criteria through the duration of the campaign.

A client may determine to track store visits by certain users. A client may pre-load the device identifiers of those mobile devices associated with users (for example, device identifiers to whom the client has previously delivered a certain ad campaign or have mentioned the business on twitter or device identifiers that match certain demographic information), and the system would separately store the pre-loaded device identifiers s that interacted with the Xone beacon 106.

A key component of the Xone system 100 is that only the local business 102 that has installed the Xone beacon 106 may access data collected through that Xone beacon 106. It is possible that since an Xone beacon 106 is only emitting a signal, others may determine that signal and listen to the Xone beacon 106. This problem can be solved by changing the signal that the Xone beacon 106 transmits using a pre-determined scheme—the signal would change at a pre-determined time and the new signals would only be known to the Xone beacon 106 and the Xone system 100. For example, an Xone beacon 106 would change the signal it transmits every five days. By incorporating attribeacons into the Xone system 100, different beacon signals may be employed for different ad networks or campaigns while still only installing a single beacon device. (An attribeacon is a programmable transmission device that may transmit multiple sets of identifiers substantially simultaneously as described in U. S. patent application Ser. No. 14/670,992 filed Mar. 27, 2015 and entitled “Beacon Device For Enhancing Measurements Of The Effectiveness Of Mobile Notifications,” which is incorporated herein by reference in its entirety.).

In an example, the Xone system 100 may have a feature that may permit a business location to decide which apps and third-party ad networks may listen to the Xone beacon 106 installed in the business location. For example, Business D may determine that it only wants its own Business D app, Weather.com and Mapquest to listen for its beacons, and then no other apps in the Xone app network would listen for or register Business Ds' beacons. Another example is that Business D wants Facebook to be able to listen to its beacons, in order to run an integrated Facebook campaign—Business D could allow this through the Beaconet without having to install a separate Facebook beacon.

Some business locations may want the Xone beacon 106 to cover a larger or smaller area, depending on the size of the store or how many Xone beacons 106 will be installed in the business location (e.g., one in the shoe department, one in the adjacent bike department). The preferred size of the area may also change after an Xone beacons 106 has been installed (e.g., a store may reduce the size of its shoe department). This situation may be addressed by calibrating the strength of the beacon signal (and, thus, the area of coverage) through the Xone application 112.

The Xone system 100 may improve tracking of advertising conversion and may be incorporated in the a mobile ad network that charges advertisers per visit detected by a beacon or per view of the in-store listing through an Xone application 112. An advertiser bids a certain amount to be paid to the ad network per Xone visit or Xone screen view, a mobile advertising network that charges advertisers per visits detected by an Xone beacon 106. The key to determining how many visits are attributable to the ad campaign is maintaining a control group that does not see the ads. The lift in visits over the control group—or the lift in people who view the in-store alert - is the visits charged.

The Xone system 100 may also be a pathway for an API for whatever a store wants. To illustrate this, when a user triggers an Xone beacon 106 at a business location, a notification (in app or otherwise) may prompt the consumer 118 to use the device in a way that is appropriate for the business location. For example, if an Xone beacon 106 in a hotel is triggered, an in-app alert may be triggered.

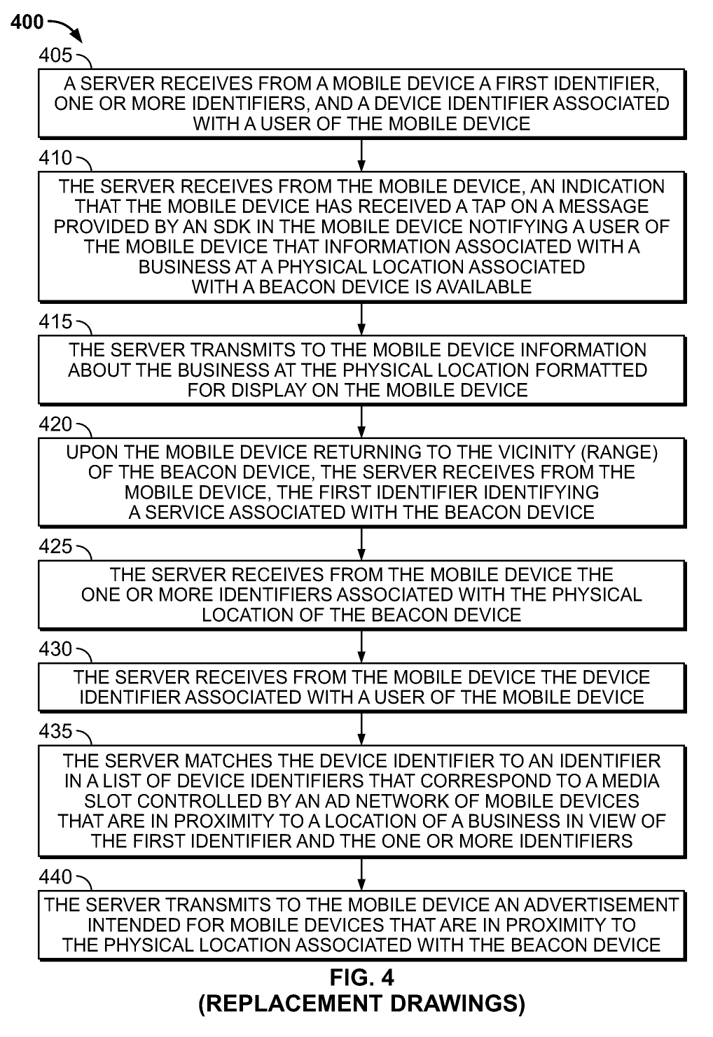

FIG. 4 is a flow diagram illustrating an example of a method 400 to operate a Xone server 104. The method 400 may be performed by at least one processor of the Xone server 104 of FIG. 1 and may comprise hardware (e.g., circuitry, dedicated logic, programmable logic, microcode, etc.), software (e.g., instructions run on a processing device), or a combination thereof. In one example, the method 400 is performed by server logic 622 of the at least one processor of the Xone server 104 of FIG. 1.

As shown in FIGS. 1 and 4, at block 405, the Xone server 104 may receive from a mobile device 120 a first identifier, one or more identifiers, and a device identifier associated with a user 118 (e.g., a consumer 118) of a mobile device 120. At block 410, the Xone server 104 may receive from the mobile device 120, an indication that the mobile device 120 has received a tap on a message 200 (e.g., a tip, photo filters, song playlists, etc.) provided by an Xone SDK 116 in the mobile device 120 notifying a user 118 (e.g., a consumer 118) of the mobile device 120 that information associate with a local business 102 at the physical location associated with the Xone beacon device 106 is available. At block 415, the Xone server 104 may transmit to the mobile device 120 information about the local business 102 at the physical location formatted for display on the mobile device 120.

The Xone server 104 may receive an indication that the mobile device 120 has exited the range of the Xone beacon device 106. The Xone server 104 may receive an indication that the mobile device 120 has re-entered the range of the Xone beacon device 106 after having exited the range of the Xone beacon device 106. The Xone server 104 may receive information about the local business 102 at the physical location to transmit to the application 112 when the mobile device 120 enters or exits the range of the Xone beacon device 106. The Xone server 104 may transmit one or more advertisements at a specified time after the mobile device 120 has exited the physical location associated with the beacon device 106.

Upon the mobile device returning to the vicinity (e.g., range, zone) of the Xone beacon device 106, at block 420, the Xone server 104 may receive from the mobile device 120, the first identifier identifying a service associated with the Xone beacon device 106. At block 425, the Xone server 104 may receive from the mobile device 120 the one or more identifiers associated with the physical location of the Xone beacon device 106. At block 430, the Xone server 104 may receive from the mobile device 120 the device identifier associated with a user (e.g., a consumer 118) of the mobile device 120.

At block 435, the Xone server 104 may match the device identifier to an identifier in a list of anonymous identifiers that correspond to a media slot controlled by an ad network of mobile devices 120 associated with users 118 that are in proximity to a location of a business in view of the first identifier and the one or more identifiers. In one example, the Xone server 104 may deliver advertisements using the ad network to a mobile device 120 that are in proximity to the beacon device 106 only for a first time. At block 440, the Xone server 104 may transmit to the mobile device 120 an advertisement intended for users of mobile devices 120 that are in proximity to the physical location associated with the Xone beacon device 106.

Prior to deploying the Xone beacon device 106, a client associated with the local business 102 may employ a graphical user interface of the Xone server 104 to log into an ad network 128. The client may create in the ad network 128 using the Xone server 104, an advertising campaign intended for previous visitors business at the physical location of the local business 102. The Xone server 104 may transmit to the ad network 126, the first identifier, the one or more identifiers, and the device identifier to be stored in a list of device identifiers associated with users (e.g., consumers 118) that have returned to the local business 102 at the physical location.

Later, the Xone server 104 may receive from the client, a login to an analytics engine 124 of the Xone server 104. The Xone server 104 may receive from the client a request for a report on visits generated by advertising campaign intended for mobile devices 120 of visitors (e.g., consumers 118) that are in proximity to the local business 102 at the physical location. The Xone server 104 may display to the client entries in a list identifying users of mobile devices 120 who have returned to the local business 102 associated with the physical location of the beacon device 106.

For certain applications, there may be privacy restrictions. In an example, the local business 102 may not be permitted to know which consumers 118 saw the ad—however, the business 102 may be permitted to know if the consumers 118 were in a group that the ad was targeted to. This is because not all consumers 118 in a custom audience for an ad may see an ad (say, if they did not log onto Facebook or if other ads were set to be served before those provided by the local business 102).

The Xone server 104 may receive in a graphical user interface from a developer 110 of an application executed by the mobile device 120 that provides the first identifier and the one or more identifiers, information about the local business 102 at the physical location provided by the application 112 for the purpose of monetizing the application. Monetizing the application 112 may comprise how much the developer 110 desired to be paid any time an advertisement is transmitted to the application 112.

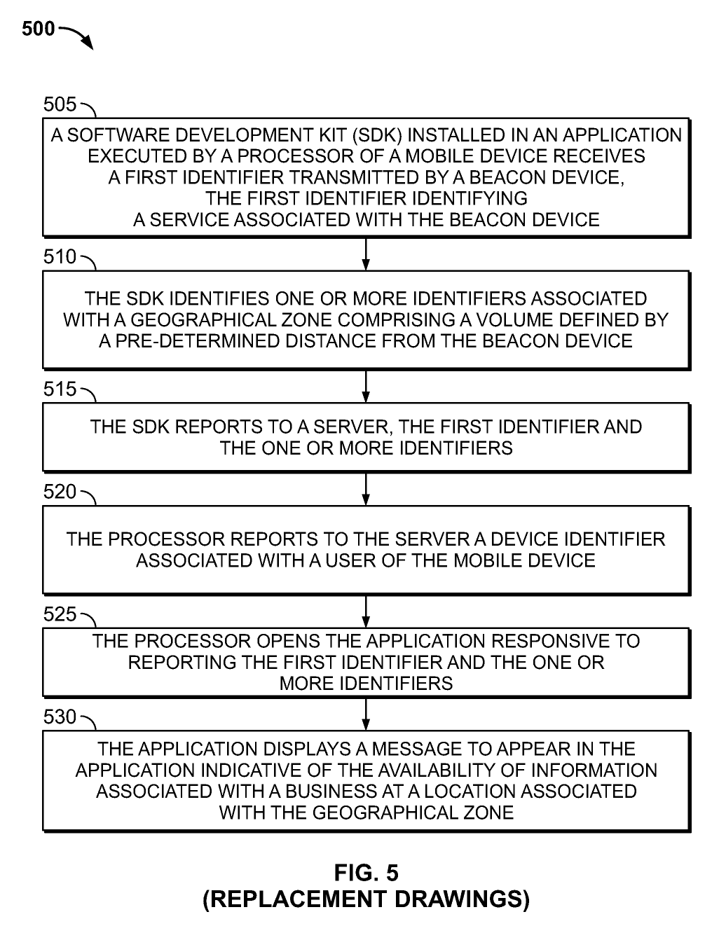

FIG. 5 is a flow diagram illustrating an example of a method 500 to operate an Xone SDK 114 installed in an application 112 executed by a processor (not shown) of a mobile device 116. The method 500 may be performed by at least one processor of the mobile device 116 of FIG. 1 and may comprise hardware (e.g., circuitry, dedicated logic, programmable logic, microcode, etc.), software (e.g., instructions run on a processing device), or a combination thereof. In one example, the method 500 is performed by device logic 622 of the processor of the mobile device 116 of FIG. 1.

As shown in FIGS. 1 and 5, at block 505, the Xone software development kit (SDK) 116 installed in an application 112 executed by a processor (not shown) of a mobile device 120 (e.g., an iPhone, Android phone, etc.) may receive a first identifier transmitted by a Xone beacon device 106. The first identifier may identify a service associated with the Xone beacon device 106 or may be an identifier for all Xone beacon devices 106. At block 510, the Xone SDK 116 may identify one or more identifiers associated with a geographical zone comprising a volume defined by a pre-determined distance from the Xone beacon device 106. The predetermined distance from the Xone beacon device 106 may be centered about a physical location of the beacon device 106 and terminated by the physical location of the mobile device 120. Identifying the one or more identifiers may comprise searching for a specific one or more identifiers assigned by the local business 102 to the location. Identifying the one or more identifiers may comprise ranging for the one or more identifiers associated with a predetermined radius of the location of the beacon device.

At block 515, the Xone SDK 116 may report to the Xone sever 104 the first identifier and the one or more identifiers. At block 520, the processor of the mobile device 120 may report to the Xone server 104 a device identifier associated with a user (e.g., the consumer 118) of the mobile device 120. At block 525, the processor of the mobile device 120 may open the application 112 responsive to reporting the first identifier and the one or more identifiers. At block 530, the application 112 may display a message to appear in the application 112 indicative of the availability of information associated with a business at the location associated with the geographical zone.

The mobile device 120 may receive a tap on the message from the user (e.g., the consumer 118). The application 112 may transmit to the Xone server 104 an indication of a tap on the message. The application 112 may receive and display the information associated with a business at the location.

The mobile device 120 may transmit an indication that the mobile device 120 has exited the range of the Xone beacon device 106. The mobile device 120 may further transmit an indication that the mobile device 120 has entered the range of the Xone beacon device 106 after having exited the range of the Xone beacon device 106.

The application 112 may be an application provided by the local business 102.

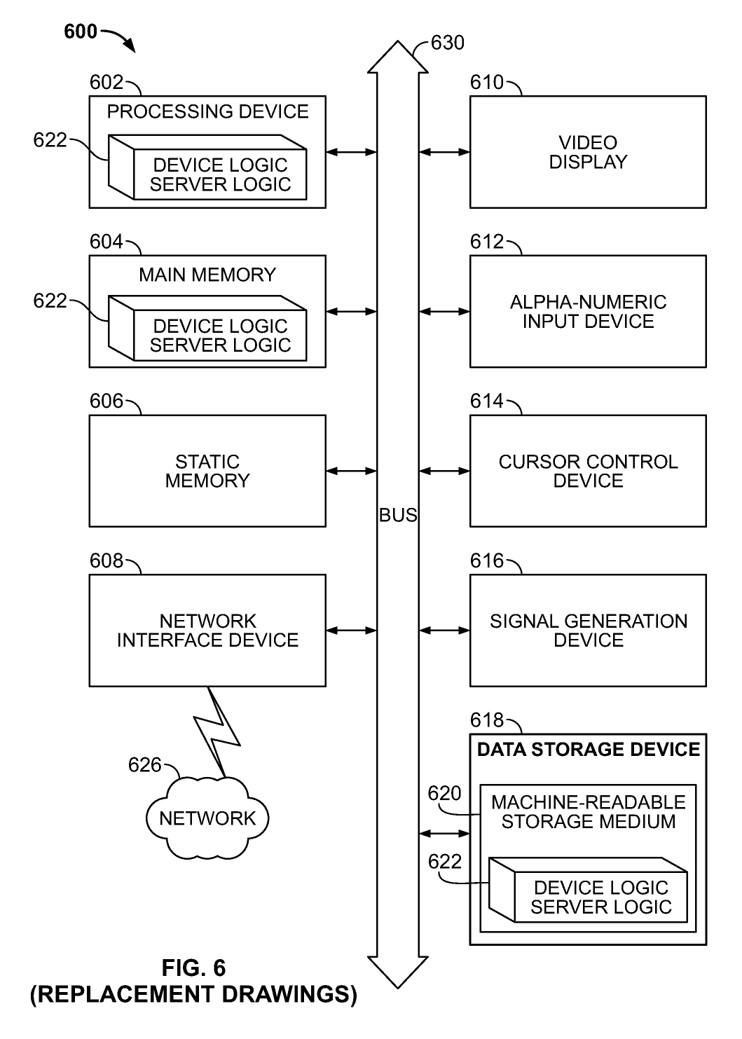

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute device logic or server logic for performing the operations and steps discussed herein.

Computer system 600 may further include a network interface device 608. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

Data storage device 618 may include a machine-readable storage medium (or more specifically a computer-readable storage medium) 620 having one or more sets of instructions embodying any one or more of the methodologies of functions described herein. Device logic of may also reside, completely or at least partially, within main memory 604 and/or within processing device 602 during execution thereof by computer system 600; main memory 604 and processing device 602 also constituting machine-readable storage media. Device logic or server logic 622 may further be transmitted or received over a network 626 via network interface device 608.

Machine-readable storage medium 620 may also be used to store the device queue manager logic persistently. While machine-readable storage medium 620 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a server from a mobile device, a first identifier identifying a service associated with a beacon device;
receiving, by the server from the mobile device, one or more identifiers associated with a physical location of the beacon device;
receiving, by a server from the mobile device, a device identifier associated with the user of the mobile device;
matching, by the server, the device identifier to an identifier in a list of device identifiers that correspond to a media slot controlled by an ad network of mobile devices that are in proximity to a location of a business in view of the first identifier and the one or more identifiers; and
transmitting, by the server to the mobile device, an advertisement intended for mobile devices that are in proximity to the physical location associated with the beacon device.

2. The method of claim 1, further comprising, prior to receiving the first identifier:
receiving, by the server from the mobile device, the first identifier, the one or more identifiers, and the device identifier;
receiving, by the server from the mobile device, an indication that the mobile device has received a tap on a message provided by an SDK in the mobile device notifying a user of the mobile device that information associate with a business at the physical location associated with the beacon device is available; and
transmitting, by the server to the mobile device, information about the business at the physical location formatted for display on the mobile device.

3. The method of claim 2, further comprising:
logging, by the server, into an ad network;
creating, in the ad network using the server, an advertising campaign intended for mobile devices that are in proximity to the business at the physical location; and
transmitting, by the server to the ad network, the first identifier, the one or more identifiers, and the device identifier to be stored in a list of identifiers associated with users of mobile devices that have returned to the business at the physical location.

4. The method of claim 3, further comprising:
receiving, by the server, a login to an analytics engine of the server;
receiving, by the server, a request for a report on visits generated by advertising campaign intended for mobile devices that are in proximity to the business at the physical location; and
displaying, by the server, entries in a list identifying mobile devices that have returned to the business associated with the physical location of the beacon device.

5. The method of claim 1, further comprising receiving, by the server, an indication that the mobile device has exited the range of the beacon device.

6. The method of claim 1, further comprising receiving, by the server, an indication that the mobile device has entered the range of the beacon device after having exited the range of the beacon device.

7. The method of claim 1, further comprising:
receiving, by the server, information about the business at the physical location to transmit to the application when the mobile device enters or exits the range of the beacon device.

8. The method of claim 1, further comprising:
transmitting, by the server, one or more advertisements at a specified time after the mobile device has exited the physical location associated with the beacon device.

9. The method of claim 1, further comprising:
receiving, by the server in a graphical user interface from a developer of an application executed by the mobile device that provides the first identifier and the one or more identifiers, information about the business at the physical location provided by the application for the purpose of monetizing the application.

10. The method of claim 9, wherein monetizing the application comprises how much the developer desired to be paid any time an advertisement is transmitted to the application.

11. A system, comprising:
a memory;
a processor, operatively coupled to the memory, the processor to:
receive, from a mobile device, a first identifier identifying a service associated with a beacon device;
receive, from the mobile device, one or more identifiers associated with a physical location of the beacon device;
receive, from the mobile device, an device identifier associated with a user of the mobile device;
match the device identifier to an identifier in a list of device identifiers that correspond to a media slot controlled by an ad network of mobile devices that are in proximity to a location of a business in view of the first identifier and the one or more identifiers; and
transmit, to the mobile device, an advertisement intended for mobile devices that are in proximity to the physical location associated with the beacon device.

12. The system of claim 11, wherein the processor is further to, prior to receiving the first identifier:
receive, from the mobile device, the first identifier, the one or more identifiers, and the device identifier;
receive, from the mobile device, an indication that the mobile device has received a tap on a message provided by an SDK in the mobile device notifying a user of the mobile device that information associate with a business at the physical location associated with the beacon device is available; and
transmit, to the mobile device, information about the business at the physical location formatted for display on the mobile device.

13. The system of claim 12, wherein the processor is further to:
log into an ad network;
create, in the ad network, an advertising campaign intended for mobile devices that are in proximity to the business at the physical location; and
transmit, to the ad network, the first identifier, the one or more identifiers, and the device identifier to be stored in a list of identifiers of mobile devices that have returned to the business at the physical location.

14. The system of claim 13, wherein the processor is further to:
receive a login to an analytics engine of the server;
receive a request for a report on visits generated by advertising campaign intended for mobile devices that are in proximity to the business at the physical location; and
display entries in a list identifying mobile devices that have returned to the business associated with the physical location of the beacon device.

15. A method, comprising:
receiving, by a software development kit (SDK) installed in an application executed by a processor of a mobile device, a first identifier transmitted by a beacon device, the first identifier identifying a service associated with the beacon device;
identifying, by the SDK, one or more identifiers associated with a geographical zone comprising a volume defined by a pre-determined distance from the beacon device;
reporting, by the SDK to a server, the first identifier and the one or more identifiers;
reporting, by the processor to the server, a device identifier associated with a user of the mobile device;
opening, by the processor, the application responsive to reporting the first identifier and the one or more identifiers; and
displaying, by the application, a message to appear in the application indicative of the availability of information associated with a business at a location associated with the geographical zone.

16. The method of claim 15, wherein the predetermined distance from the beacon device is centered about a physical location of the beacon device and terminated by the physical location of the mobile device.

17. The method of claim 15, further comprising:
receiving, by the mobile device, a tap on the message;
transmitting, by the application to the server, an indication of a tap on the message; and
receiving and displaying, by the application on the mobile device, the information associated with a business at the location.

18. The method of claim 15, wherein identifying the one or more identifiers comprises searching for a specific one or more identifiers assigned by the business to the location.

19. The method of claim 15, wherein identifying the one or more identifiers comprises ranging for the one or more identifiers associated with a predetermined radius of the location of the beacon device.

20. The method of claim 15, further comprising transmitting an indication that the mobile device has exited the range of the beacon device.

21. The method of claim 15, further comprising transmitting an indication that the mobile device has entered the range of the beacon device after having exited the range of the beacon device.

22. The method of claim 15, wherein the application is a third party application provided by the business.

23. A non-transitory computer-readable medium storing instructions that when executed by a software development kit (SDK) installed in an application executed by the processor of a mobile device, cause the processor to:
receive a first identifier transmitted by a beacon device, the first identifier identifying a service associated with the beacon device;
identifying, by the SDK, one or more identifiers associated with a geographical zone comprising a volume defined by a pre-determined distance from the beacon device;
report, to a server, the first identifier and the one or more identifiers;
report, to the server, a device identifier associated with a user of the mobile device;
open the application responsive to reporting the first identifier and the one or more identifiers; and
display a message to appear in the application indicative of the availability of information associated with a business of the location associated with a geographical zone.

24. The non-transitory computer-readable medium of claim 23, wherein the predetermined distance from the beacon device is centered about a physical location of the beacon device and terminated by the physical location of the mobile device.

25. The non-transitory computer-readable medium of claim 23, wherein the processor is further to:
receive, from the mobile device, an indication of a tap on the message;
transmit, to the server, an indication of a tap on the message; and
receive and display, on the mobile device, the information associated with a business at the location.
